(19) United States
(12) Patent Application Publication
(10) Pub. No.: US 2026/0067761 A1
(43) Pub. Date: Mar. 5, 2026

(54) VOICE CALL MANAGEMENT TECHNIQUES

(71) Applicant: Apple Inc., Cupertino, CA (US)

(72) Inventors: Tushar K. Patel, Milpitas, CA (US); Kun Yu, Milpitas, CA (US); Riteshkumar S. Patel, Cupertino, CA (US); Shadi Iskander, Ergolding (DE); Yuanye Wang, San Jose, CA (US)

(21) Appl. No.: 19/315,336

(22) Filed: Aug. 29, 2025

Related U.S. Application Data
(60) Provisional application No. 63/689,548, filed on Aug. 30, 2024.

(51) Int. Cl. H04W 36/00; H04L 65/65; H04W 36/30; H04W 76/19

(52) U.S. Cl. CPC H04W 36/0058; H04L 65/65; H04W 36/305; H04W 76/19

(57) ABSTRACT

The present disclosure generally relates to improving the performance of voice calls in scenarios with poor radio conditions or high interference. During an active voice call, a user equipment (UE) may start a first timer after determining, from one or more measurements of a first cell, that at least one radio channel condition of the first cell is below a threshold. The UE may initiate a second timer after transmitting a measurement report that indicates the one or more measurements of the first cell. If the first timer or the second timer expires, the UE may declare radio link failure (RLF) and initiate a connection reestablishment procedure.

### CROSS-REFERENCE TO RELATED APPLICATIONS

This application claims priority to U.S. Provisional Application No. 63/689,548, filed on Aug. 30, 2024, the entirety of which is incorporated herein by reference.

### TECHNICAL FIELD

The present disclosure relates generally to wireless communication, and more specifically to managing voice calls.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using one or more wireless network protocols, such as protocols described in various telecommunication standards promulgated by the ETSI Third Generation Partnership Project (3GPP). The wireless communication networks facilitate mobile broadband service using technologies such as orthogonal frequency-division multiple access (OFDMA), multiple input multiple output (MIMO), advanced channel coding, massive MIMO, beamforming, and/or other features.

### SUMMARY

The techniques described herein generally relate to voice call performance enhancements for marginal radio conditions, or high interference scenarios, or both. One aspect of the present disclosure relates to a method that includes: initiating a first timer during a voice communication session based on determining, from one or more measurements of a first cell, that at least one radio channel condition of the first cell is below a threshold; initiating a second timer after transmitting a measurement report indicating the one or more measurements of the first cell; and declaring radio link failure (RLF) upon expiration of the first timer or the second timer.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example wireless network.

FIG. 2 illustrates an example signaling diagram in a wireless network.

FIGS. 3-5 illustrate example call flows of voice communication sessions.

FIG. 6 illustrates a flowchart of an example method for voice call management.

FIG. 7 illustrates an example user equipment (UE).

FIG. 8 illustrates an example access node.

### DETAILED DESCRIPTION

During an active voice call in a wireless communication network, a user equipment (UE) may periodically measure cell radio conditions (also referred to as radio channel conditions or signal quality metrics) to ensure good voice quality. Examples of radio channel conditions include, but are not limited to, signal to noise ratio (SNR), signal to interference and noise ratio (SINR), reference signal received power (RSRP), reference signal received quality (RSRQ), received signal strength indicator (RSSI), block error rate (BLER), channel quality indicator (CQI), and the like. If the signal quality of the serving cell degrades or the signal quality of a neighbor cell improves relative to the serving cell, the UE may transmit a measurement report to inform the network of the change in channel conditions. Upon receiving the measurement report from the UE, the network can instruct the UE to perform a handover from the serving cell to the neighbor cell with more favorable channel conditions. In response to the handover command, the UE may complete the handover and continue the voice call on the new serving cell.

In some cases, however, radio conditions of the original serving cell may deteriorate (e.g., due to interference or a location of the UE) and the UE may not receive a handover command from the network. For example, poor channel conditions may prevent the network from receiving/decoding the measurement report, or the UE may be unable to receive/decode the handover command from the network. When this occurs, the UE may remain connected, despite the poor channel conditions, to the original serving cell until the end of a real-time protocol (RTP) timeout period, at which point the UE may declare radio link failure (RLF). This can lead to call drops, extended delays, poor voice quality, signaling overhead, and excess power consumption, among other issues.

The techniques described herein can mitigate these issues by reducing the amount of time the UE waits before declaring RLF and reestablishing network connectivity. For example, rather than waiting for an RTP timeout period to expire, the UE can use one or more event-triggered timers to determine when to declare RLF. The UE may start a first timer after detecting that the SNR of the original serving cell is below a threshold. The UE may start a second timer after transmitting a measurement report to the network. If the first timer expires and the UE is still attempting to transmit the measurement report, the UE may declare RLF and initiate a radio resource control (RRC) reestablishment process. Likewise, if the second timer expires before the UE receives a mobility handover command from the network, the UE may declare RLF and initiate an RRC reestablishment process.

Using these timers, instead of waiting for RTP timeout (which is typically between 10 and 20 seconds from the last RTP packet received from the network), the UE can initiate RLF recovery and continue the voice call on another cell with more favorable conditions. As a result, the end user may experience better voice quality and fewer call drops. The UE may also consume less power and perform fewer retransmissions (e.g., of the measurement report). Aspects of the present disclosure can thus improve the efficiency and reliability of voice communications in scenarios with poor radio conditions, high interference, etc.

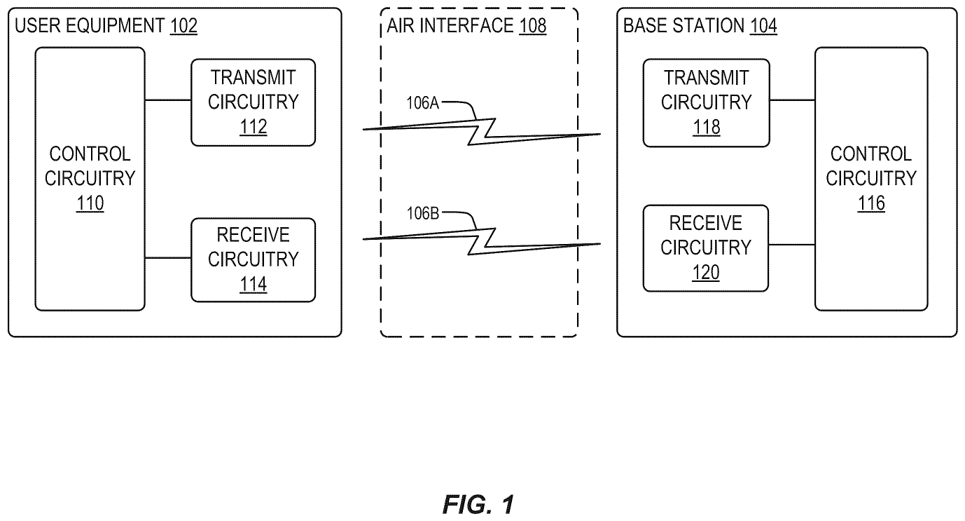

FIG. 1 illustrates an example wireless network 100. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 is a Standalone (SA) network, e.g., that incorporates Fifth Generation (5G) New Radio (NR). In some other implementations, the wireless network 100 is a Non-Standalone (NSA) network that incorporates Long Term Evolution (LTE) and 5G NR. In these implementations, the wireless network 100 may be a E-UTRA (Evolved Universal Terrestrial Radio Access)-NR Dual Connectivity (EN-DC) network, or an NR-EUTRA Dual Connectivity (NE-DC) network. Furthermore, wireless networks implementing one or more other types of communication standards are possible, including future 3GPP systems (e.g., Sixth Generation (6G)), Institute of Electrical and Electronics Engineers (IEEE) 802.11 technology, or the like. While aspects may be described herein using terminology commonly associated with 5G NR, aspects of the present disclosure can be applied to other systems, such as systems subsequent to 5G (e.g., 6G).

In the wireless network 100, the UE 102 and any other UE in the system may be, for example, any of a laptop computer, smartphone, tablet computer, machine-type device (such as smart meters or specialized devices for healthcare), intelligent transportation system, or any other wireless device. In the wireless network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by one or more antennas integrated with the base station 104. The service areas can be divided into a number of sectors associated with one or more particular antennas. Such sectors may be physically associated with one or more fixed antennas or may be assigned to a physical area with one or more tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include application-specific circuitry, baseband circuitry, or any of various combinations thereof. The transmit circuitry 112 and receive circuitry 114 may be adapted to transmit and receive data, respectively, and may include radio frequency (RF) circuitry and/or front-end module (FEM) circuitry.

In various implementations, aspects of the transmit circuitry 112, receive circuitry 114, and/or control circuitry 110 may be integrated in various ways to implement the operations described herein. The control circuitry 110 may be adapted or configured to perform various operations, such as those described elsewhere in this disclosure related to a UE. For instance, the control circuitry 110 can determine that an SNR of a serving cell is below a threshold and initiate a first RLF timer.

The transmit circuitry 112 can perform various operations described herein. For example, the transmit circuitry 112 can transmit an RRC reestablishment request to another cell in response to determining that the first RLF timer has expired. Additionally, the transmit circuitry 112 may transmit using a plurality of multiplexed uplink physical channels. The plurality of uplink physical channels may be multiplexed, e.g., according to time division multiplexing (TDM) or frequency division multiplexing (FDM), and in some implementations, along with carrier aggregation. The transmit circuitry 112 may be configured to receive block data from the control circuitry 110 for transmission on the air interface 108.

The receive circuitry 114 can perform various operations described herein. For instance, the receive circuitry 114 can receive a mobility handover command from a serving cell and reset a second RLF timer in response. Additionally, the receive circuitry 114 may receive a plurality of multiplexed downlink physical channels from the air interface 108 and relay the physical channels to the control circuitry 110. The plurality of downlink physical channels may be multiplexed, e.g., according to TDM or FDM, e.g., along with carrier aggregation. The transmit circuitry 112 and the receive circuitry 114 may transmit and receive, respectively, both control data and content data (e.g., messages, images, video, etc.) structured within data blocks that are carried by the physical channels.

FIG. 1 also illustrates the base station 104. In some implementations, the base station 104 may be a 5G radio access network (RAN), a next generation RAN, a E-UTRAN, a non-terrestrial cell, or a legacy RAN, such as a UTRAN. As used herein, the term “5G RAN” or the like may refer to the base station 104 that operates in an NR wireless network 100, and the term “E-UTRAN” or the like may refer to a base station 104 that operates in an LTE wireless network 100. The UE 102 utilizes connections (or channels) 106A, 106B, each of which includes a physical communications interface or layer.

The base station 104 circuitry may include control circuitry 116 coupled (directly or indirectly) with transmit circuitry 118 and/or receive circuitry 120. The transmit circuitry 118 and receive circuitry 120 may each be coupled (directly or indirectly) with one or more antennas that may be used to enable communications via the air interface 108. The transmit circuitry 118 and receive circuitry 120 may be adapted to transmit and receive data, respectively, addressed to any UE connected to the base station 104. The receive circuitry 120 may receive a plurality of uplink physical channels from one or more UEs, including the UE 102.

In FIG. 1, the one or more channels 106A, 106B are illustrated as an air interface to enable communicative coupling, and can be consistent with cellular communications protocols, such as an LTE protocol, Advanced LTE (LTE-A) protocol, LTE-based access to unlicensed spectrum (LTE-U), NR protocol, NR-based access to unlicensed spectrum (NR-U) protocol, and/or any other communications protocol(s). In some implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Discovery Channel (PSDCH), and a Physical Sidelink Broadcast Channel (PSBCH).

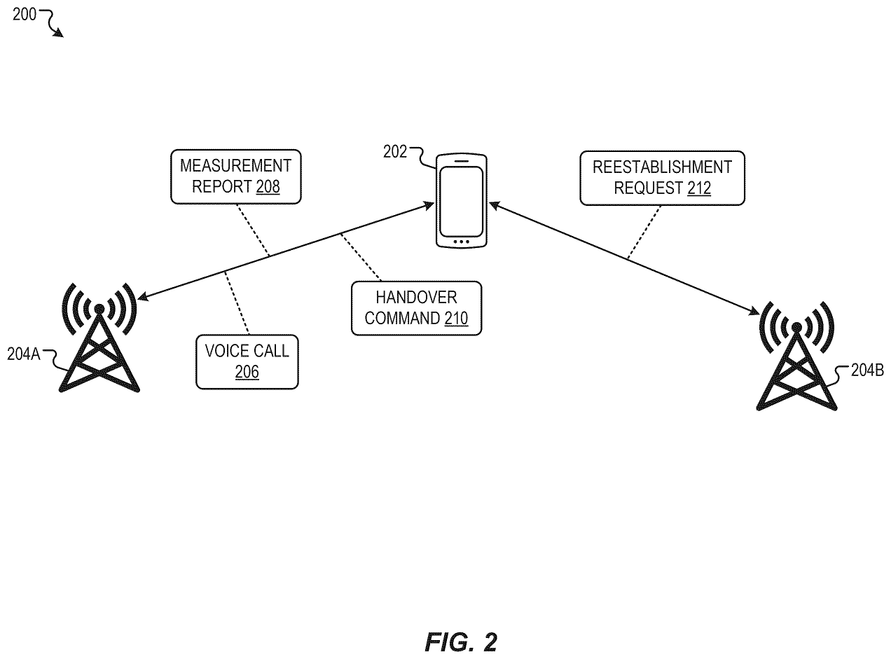

FIG. 2 illustrates an example signaling diagram 200 in a wireless network, such as the wireless network 100 described above. The signaling diagram 200 includes a UE 202, a base station 204a, and a base station 204b, which may be examples of corresponding devices shown and described with reference to FIG. 1. In the example signaling diagram 200 depicted in FIG. 2, the UE 202 may use a combination of event-triggered timers to declare RLF and transfer an active voice call 206 from a serving cell of the base station 204a to a neighbor cell of the base station 204b when radio conditions of the serving cell degrade.

The technical standard for voice over NR (VoNR) and voice over LTE (VoLTE) calls defined by 3GPP also applies to enhanced packet switched fallback (EPSFB) calls from 5G to LTE. The 3GPP standard also defines Measurement Request and Measurement Report based on 5G and LTE events. The UE 202 may perform a radio access technology (RAT) transition from 5G to LTE during an EPSFB call. Providing high-quality voice services to users in marginal (e.g., degraded, deteriorating) radio conditions and high interference scenarios is desirable.

The techniques described herein can improve voice call performance (e.g., for VoNR/VoLTE/EPSFB calls) in marginal radio conditions when the SNR/RSRQ of the serving cell degrades. In particular, voice user experience can be improved by declaring RLF and quickly reestablishing an RRC connection with a neighbor cell instead of waiting for RTP timeout, which is typically between 10 and 20 seconds (based on network configuration). This can improve user experience, multi-SIM performance, voice quality, UE power consumption, call reliability, and network overhead.

In some examples, the UE 202 may be configured to perform frequency measurements of the serving cell and the neighbor cell during an active voice call. If radio conditions of the serving cell deteriorate or radio conditions of the neighbor cell improve relative to the serving cell, the UE 202 may transmit a measurement report 208 to the base station 204a. The measurement report 208 may include frequency measurements of the neighbor cell and/or the serving cell.

If the measurement report 208 is successfully received, the base station 204a may transmit a mobility handover command 210 to the UE 202. The handover command 210 may instruct the UE 202 to perform a handover from the serving cell to the neighbor cell with more favorable radio conditions. However, if radio conditions of the serving cell deteriorate and the base station 204a fails to receive the measurement report 208 and/or the UE 202 fails to receive the handover command 210, the UE 202 may remain connected to the serving cell until an RTP timeout period expires, at which point the UE 202 initiates call drop and declares RLF.

In accordance with the techniques described herein, the UE 202 may initiate a first timer once the SNR of the serving cell drops below a threshold value (e.g., −7 dB, −5 dB, −3 dB). The UE 202 may initiate a second timer after attempting to send the measurement report 208 to the base station 204a. If the first timer expires and the UE 202 is still trying to send the measurement report 208, the UE 202 may declare RLF and send an RRC reestablishment request 212 to the base station 204b. Likewise, if the second timer expires before the UE 202 receives the mobility handover command 210 from the base station 204a, the UE 202 may declare RLF and send an RRC reestablishment request 212 to the base station 204b (e.g., a neighbor cell with more favorable radio conditions). Once the RRC reestablishment process is complete, the UE 202 may continue the active voice call 206 on the neighbor cell. In doing so, rather than waiting for the RTP timeout period to expire, the UE 202 can sustain the voice call 206 using the neighbor cell when radio conditions of the serving cell decline.

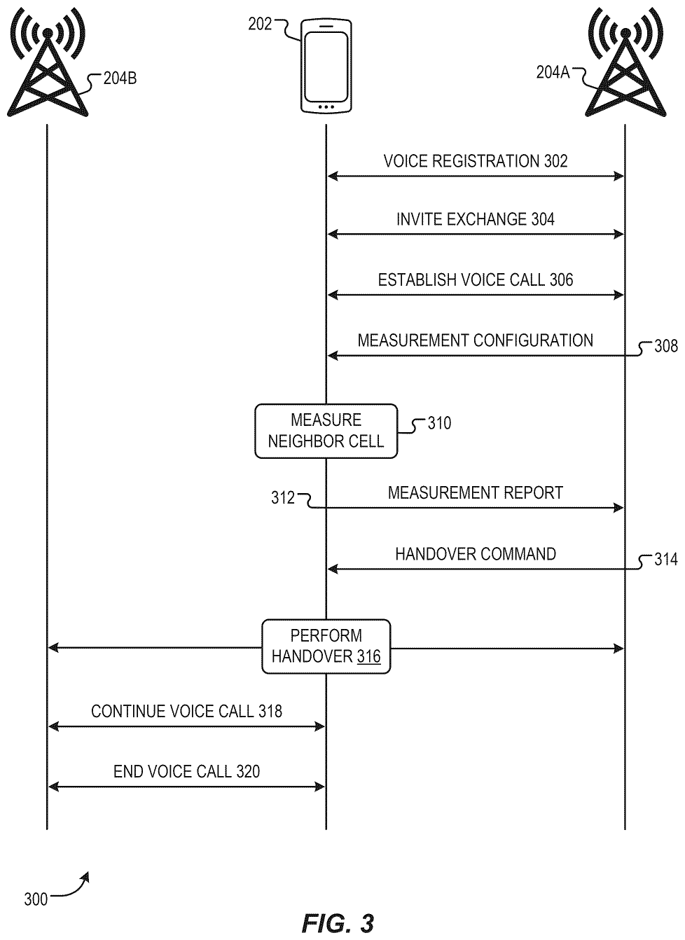

FIG. 3 illustrates an example call flow 300 of a voice communication session. In some implementations, the call flow 300 may be an example of a VoNR or VoLTE call flow. The call flow 300 may implement one or more aspects of the wireless network 100 and the signaling diagram 200. For example, the call flow 300 includes a UE 202, a base station 204a, and a base station 204b, which may be examples of corresponding elements described in the preceding figures. In the example call flow 300 depicted in FIG. 3, the UE 202 may perform scheduled cell measurements and perform a handover from a first cell of the base station 204a (e.g., a serving cell) to a second cell of the base station 204b (e.g., a neighbor cell) in response to detecting marginal radio conditions.

At 302, the UE 202 performs a voice registration process, such as a session initiation protocol (SIP) VoNR registration process or an LTE VoLTE registration process, to register with a 5G or LTE network.

At 304, a voice call is dialed and an SIP invite is sent to the network, which responds with an SIP 100 message.

At 306, the UE 202 receives an SIP 200 message from the network and the voice call is successfully established using the serving cell of the base station 204a.

At 308, the network provides an intra/inter-frequency measurement configuration for LTE or NR.

At 310, the UE 202 performs measurements of the serving cell and the neighbor cell according to the network configuration.

At 312, the UE 202 transmits a measurement report to the network in response to a measurement-triggered event. For example, the UE 202 may transmit the measurement report based on determining that (i) an SNR of the serving cell is below a threshold or (ii) a difference between the SNR of the serving cell and an SNR of the neighbor cell is greater than a threshold. The measurement report may include one or more frequency measurements of the neighbor cell and/or the serving cell.

At 314, the network transmits a handover command to the UE 202 based on the measurement report. The handover command may instruct the UE 202 to perform a handover from the serving cell (e.g., a source cell) to the neighbor cell (e.g., a target cell).

At 316, the UE 202 executes the handover as instructed, for example, by performing a random access channel (RACH) procedure to establish communications with the neighbor cell.

At 318, the UE 202 continues the voice call on the neighbor cell of the base station 204b.

At 320, the user ends the voice call and an SIP BYE message is sent to the network, which responds with a corresponding SIP BYE message.

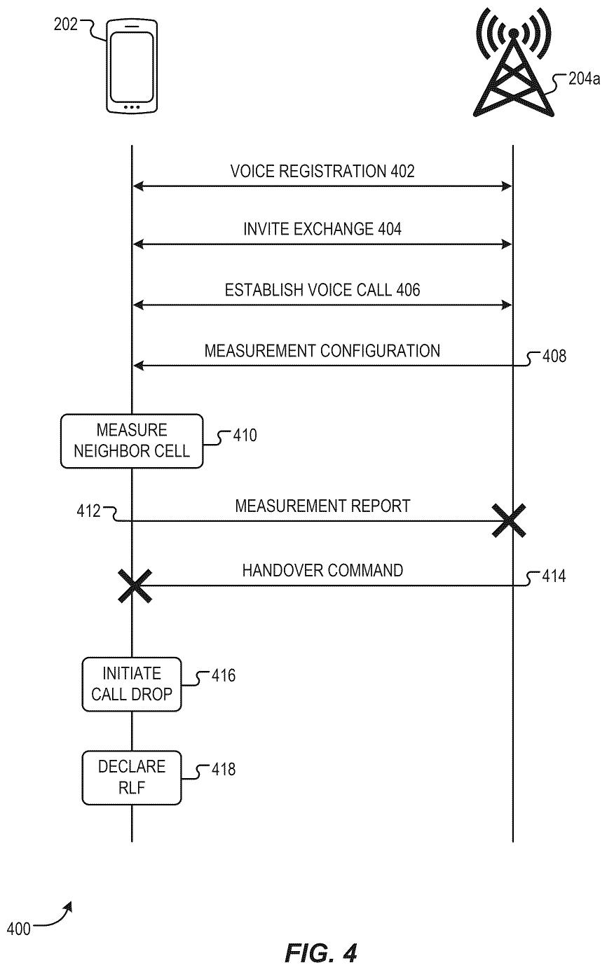

FIG. 4 illustrates an example call flow 400 of a voice communication session. The call flow 400 may be an example of a VoNR or VoLTE call flow in some cases. The call flow 400 may implement one or more aspects of the wireless network 100 and the signaling diagram 200. For example, the call flow 400 includes a UE 202, a base station 204a, and a base station 204b, which may be examples of corresponding elements described in the preceding figures. The example call flow 400 depicted in FIG. 4 illustrates a scenario where a voice call drop occurs during an active VoLTE/VoNR/EPSFB call due to RTP timeout and RLF due to Radio Link Control (RLC) max re-transmission.

At 402, the UE 202 performs a voice registration process, such as an SIP VoNR registration process or an LTE VoLTE registration process, to register with a 5G or LTE network.

At 404, a voice call is dialed and an SIP invite is sent to the network, which responds to the invite with an SIP 100 message.

At 406, the UE 202 receives an SIP 200 message from the network and the voice call is successfully established via the serving cell of the base station 204a.

At 408, the network provides a respective intra/inter-frequency measurement configuration for LTE or NR.

At 410, the UE 202 performs measurements of the serving cell and a neighbor cell (not shown) according to the network configuration provided at 408.

At 412, the UE 202 transmits a measurement report to the network in response to a measurement-triggered event. For example, the UE 202 may transmit the measurement report based on determining that (i) an SNR of the serving cell is below a threshold or (ii) a difference between the SNR of the serving cell and the SNR of a neighbor cell is greater than a threshold. The measurement report may include one or more frequency measurements of the serving cell and/or the neighbor cell.

In contrast to the example call flow 300 depicted in FIG. 3, however, the network may fail to receive/decode the measurement report due to poor radio conditions of the serving cell. For example, a low SNR of the serving cell may interfere with reception of the measurement report. Additionally, or alternatively, the UE 202 may fail to receive a mobility handover command from the network at 414. For example, the UE 202 may experience a downlink cyclic redundancy check (CRC) failure due to a degraded SNR or reference signal received quality (RSRQ) of the serving cell. This may lead to a downlink RTP packet decoding failure due to degraded SNR. In some implementations, the UE 202 may otherwise be experiencing good radio conditions (e.g., high RSRP), but a degraded SNR causes the aforementioned failures.

At 416, the UE initiates a voice call drop and sends an SIP BYE message to the network due to RTP timeout. The voice call drop may be caused (at least in part) by degraded radio conditions on the serving cell, while a good neighbor cell (e.g., another cell with better radio conditions) is available. In such cases, the UE 202 may fail to perform a handover to the neighbor cell (after sending a measurement report for the neighbor cell) because the UE 202 is unable to decode the handover command from the network on the serving cell due to poor radio conditions.

At 418, the UE declares RLF due to RLC max retransmission.

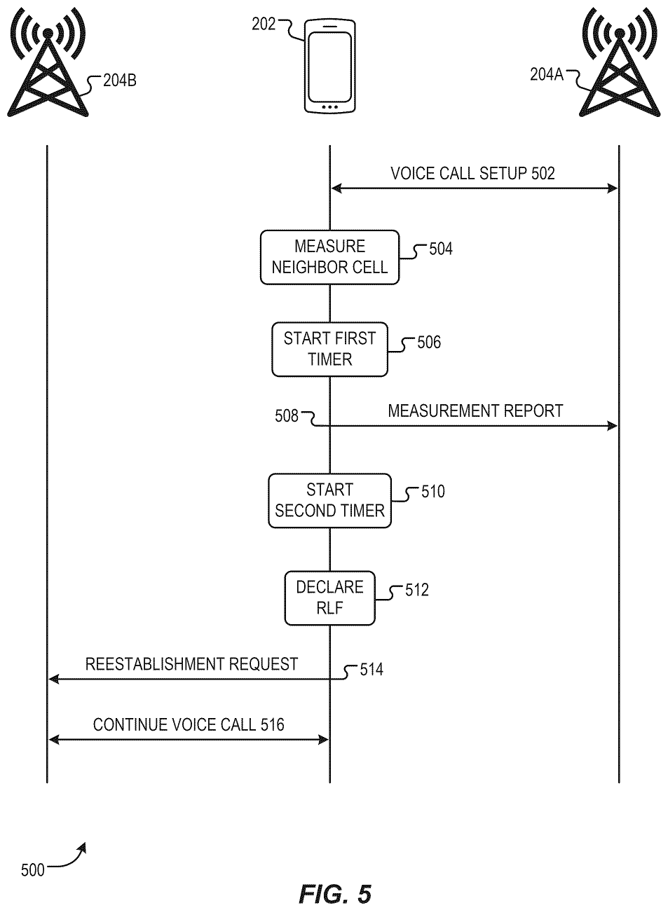

FIG. 5 illustrates an example process flow 500 of a voice communication session. In some implementations, the call flow 500 may be an example of a VoNR or VoLTE call flow. The call flow 500 may implement one or more aspects of the wireless network 100 and the signaling diagram 200. For example, the call flow 500 includes a UE 202, a base station 204a, and a base station 204b, which may be examples of corresponding elements described in the preceding figures. In the example call flow 500 depicted in FIG. 5, the UE 202 may declare RLF and reestablish connectivity with a second cell of a base station 204b after determining that at least one event-triggered measurement timer associated with a first cell of a base station 204a has expired.

At 502, the UE 202 performs a voice call setup with the network. For example, the UE 202 may establish a VoLTE call on LTE Cell A of the base station 204a (e.g., a serving cell of the UE 202), which may be associated with E-UTRA Absolute Radio Frequency Channel Number (EARFCN) X and physical cell identifier (PCI) 1.

During the active voice call, radio conditions of the serving cell may degrade due to various reasons. It is possible that the RSRP of the serving cell is good but the SNR or RSRQ of the serving cell is declining (for example, in urban environments with relatively high interference levels).

The network may configure intra-frequency or inter-frequency measurements during the active voice call. At 504, the UE 202 performs respective intra/inter-frequency cell measurements.

If a measurement event is triggered (as described with reference to FIGS. 3 and 4), the UE 202 may send a measurement report to the network at 508. The measurement report may indicate that a neighbor cell with more favorable radio conditions (e.g., the second cell of the base station 204b) is available at that location.

Similar to the example call flow 400 depicted in FIG. 4, the UE 202 may fail to send the measurement report and/or fail to receive an acknowledgement (ACK) for the measurement report from the network due to marginal radio conditions, such as low SNR. In some implementations, the UE 202 may successfully send the measurement report to the network but fail to decode the resulting downlink mobility handover command due to low SNR/RSRQ, especially in urban environments and high interference regions.

In accordance with aspects of the present disclosure, the UE 202 may instantiate two timers during the active voice call. The first timer (T1) may depend on SNR measurements and the second timer (T2) may depend on the mobility handover command. Both timers can be reconfigurable.

During the active voice call (VoLTE/VoNR/EPSFB), the UE 202 may start the T1 timer (506) if the SNR of the serving cell drops below a threshold value (e.g., −5 dB). The UE 202 may start the T2 timer (510) after trying to send a measurement report with frequency measurements of the neighbor cell.

If the T1 timer expires and the UE 202 is still trying to send a neighbor cell measurement report to the network, the UE may declare RLF (512) and initiate RRC Reestablishment on the neighbor cell (514) to continue the voice call (516). Likewise, if the T2 timer expires before the UE 202 receives a mobility handover command from the network, the UE 202 may declare RLF and initiate RRC Reestablishment on the neighbor cell (514) to continue the voice call (516).

Using the two event-based timers described above, the UE 202 can sustain/transfer the active voice call to the neighbor cell when serving cell measurements (such as SNR) degrade and a good neighbor cell is available.

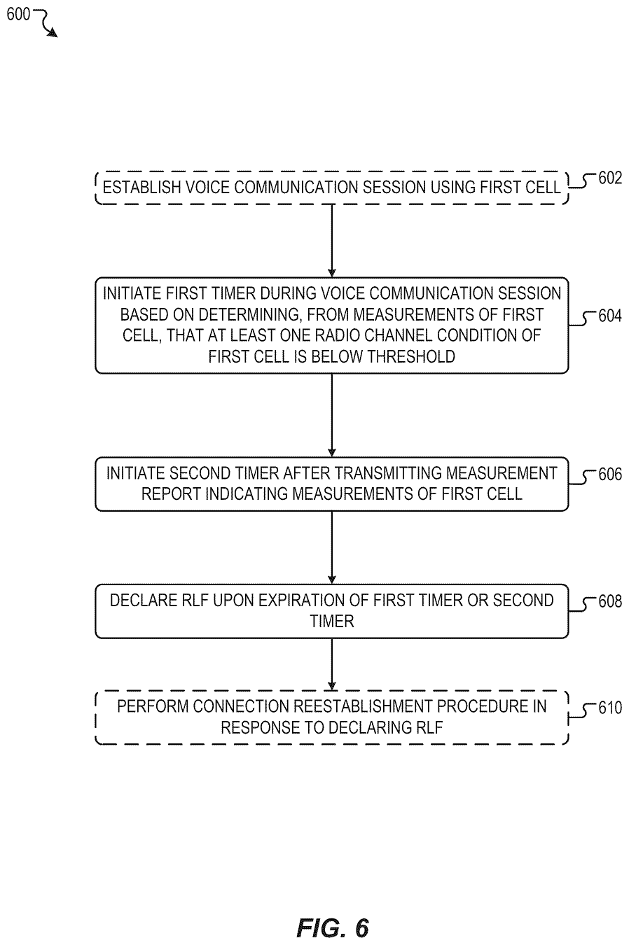

FIG. 6 illustrates a flowchart of an example method 600. For clarity of presentation, the description that follows generally describes the method 600 in the context of other figures described herein. For example, the method 600 can be performed by a UE, such as the UE 202 described with reference to FIGS. 2-5, or by any suitable system, environment, software, hardware, etc. Operations of the method 600 can be run in parallel, in combination, in loops, or in any order. The example method 600 shown in FIG. 6 can be modified or reconfigured to include additional, fewer, or different steps (not shown in FIG. 6), which can be performed in the order shown or in a different order.

At 602, the UE optionally establishes a voice communication session using a first cell of a wireless communication network (such as a cell of the base station 204a).

At 604, the UE initiates a first timer during the voice communication session based on determining, from one or more measurements of the first cell, that at least one radio channel condition of the first cell is below a threshold.

At 606, the UE initiates a second timer after transmitting a measurement report indicating the one or more measurements of the first cell.

At 608, the UE declares RLF upon expiration of the first timer or the second timer. As described herein, the expiration of the first timer or the second timer occurs prior to the expiration of an RTP timeout period.

At 610, the UE optionally performs a connection reestablishment procedure in response to declaring RLF.

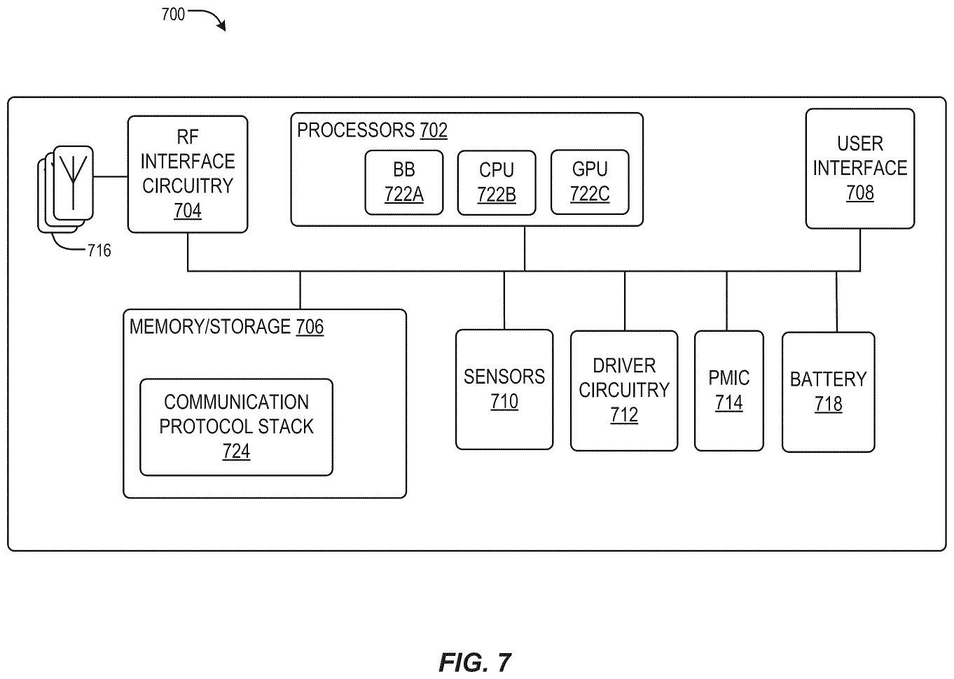

FIG. 7 illustrates an example UE 700. The UE 700 may be similar to and substantially interchangeable with UE 102 of FIG. 1.

The UE 700 may be any mobile or non-mobile computing device, such as, for example, a mobile phone, computer, tablet, industrial wireless sensors, video device (for example, cameras, video cameras, etc.), wearable devices (for example, a smart watch), relaxed-IoT devices, etc.

The UE 700 may include any/all of processor 702, RF interface circuitry 704, memory/storage 706, user interface 708, sensors 710, driver circuitry 712, power management integrated circuit (PMIC) 714, one or more antenna(s) 716, and battery 718. The components of the UE 700 may be implemented as integrated circuits (ICs), portions thereof, discrete electronic devices, or other modules, logic, hardware, software, firmware, or a combination thereof. The block diagram of FIG. 7 is intended to show a high-level view of some of the components of the UE 700. However, some of the components shown may be omitted, additional components may be present, and a different arrangement of the components shown may occur in other implementations.

The components of the UE 700 may be coupled with various other components over one or more interconnects 720, which may represent any type of interface, input/output, bus (local, system, or expansion), transmission line, trace, optical connection, etc., that allows various circuit components (on common or different chips or chipsets) to interact with one another.

The processor 702 may include one or more processors. For example, the processor 702 may include processor circuitry such as, for example, baseband processor circuitry (BB) 722A, central processor unit circuitry (CPU) 722B, and graphics processor unit circuitry (GPU) 722C. The processor 702 may include any type of circuitry or processor circuitry that executes or otherwise operates computer-executable instructions, such as program code, software modules, or functional processes from memory/storage 706 to cause the UE 700 to perform operations as described herein.

In some implementations, the baseband processor circuitry 722A may access a communication protocol stack 724 in the memory/storage 706 to communicate over a 3GPP compatible network. In general, the baseband processor circuitry 722A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 704. The baseband processor circuitry 722A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 706 may include one or more non-transitory, computer-readable media that includes instructions (for example, communication protocol stack 724) that may be executed by the processor 702 to cause the UE 700 to perform various operations described herein. The memory/storage 706 include any type of volatile or non-volatile memory that may be distributed throughout the UE 700. In some implementations, some of the memory/storage 706 may be located on the processor 702 itself (for example, L1 and L2 cache), while other memory/storage 706 is external to the processor 702 but accessible thereto via a memory interface. The memory/storage 706 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 704 may include transceiver circuitry and radio frequency front module (RFEM) that allows the UE 700 to communicate with other devices over a radio access network. The RF interface circuitry 704 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 716 and proceed to filter and amplify (with a low-noise amplifier) the signal. The signal may be provided to a receiver of the transceiver that downconverts the RF signal into a baseband signal that is provided to the baseband processor.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 716. In various implementations, the RF interface circuitry 704 may be configured to transmit/receive signals in a manner compatible with NR access technologies.

The antenna(s) 716 may include one or more antenna elements to convert electrical signals into radio waves to travel through the air and to convert received radio waves over the air into electrical signals. In some implementations, the antenna elements may be arranged into one or more antenna panels. The antenna(s) 716 may have antenna panels that are omnidirectional, directional, or a combination thereof, to enable beamforming and multiple input, multiple output communications. The antenna(s) 716 may include any/all of microstrip antennas, printed antennas fabricated on the surface of one or more printed circuit boards, patch antennas, phased array antennas, etc. The antenna(s) 716 may have one or more panels designed for one or more specific frequency bands, such as bands in FR1 or FR2.

The user interface 708 includes various input/output (I/O) devices designed to enable user interaction with the UE 700. The user interface 708 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 700.

The sensors 710 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 712 may include software and hardware elements that operate to control particular devices that are embedded in the UE 700, attached to the UE 700, or otherwise communicatively coupled with the UE 700. The driver circuitry 712 may include individual drivers allowing other components to interact with or control various input/output (I/O) devices that may be present within, or connected to, the UE 700. For example, driver circuitry 712 may include a display driver to control and allow access to a display device, a touchscreen driver to control and allow access to a touchscreen interface, sensor drivers to obtain sensor readings of sensors 710 and control and allow access to sensors 710, drivers to obtain actuator positions of electro-mechanic components or control and allow access to the electro-mechanic components, a camera driver to control and allow access to an embedded image capture device, audio drivers to control and allow access to one or more audio devices.

The PMIC 714 may manage power provided to various components of the UE 700. In particular, with respect to the processor 702, the PMIC 714 may control power-source selection, voltage scaling, battery charging, or DC-to-DC conversion.

In some implementations, the PMIC 714 may control, or otherwise be part of, various power saving mechanisms of the UE 700. A battery 718 may power the UE 700, although in some examples the UE 700 may be mounted deployed in a fixed location, and may have a power supply coupled to an electrical grid. The battery 718 may be a lithium ion battery, a metal-air battery, such as a zinc-air battery, an aluminum-air battery, a lithium-air battery, and the like. In some implementations, such as in vehicle-based applications, the battery 718 may be a typical lead-acid automotive battery.

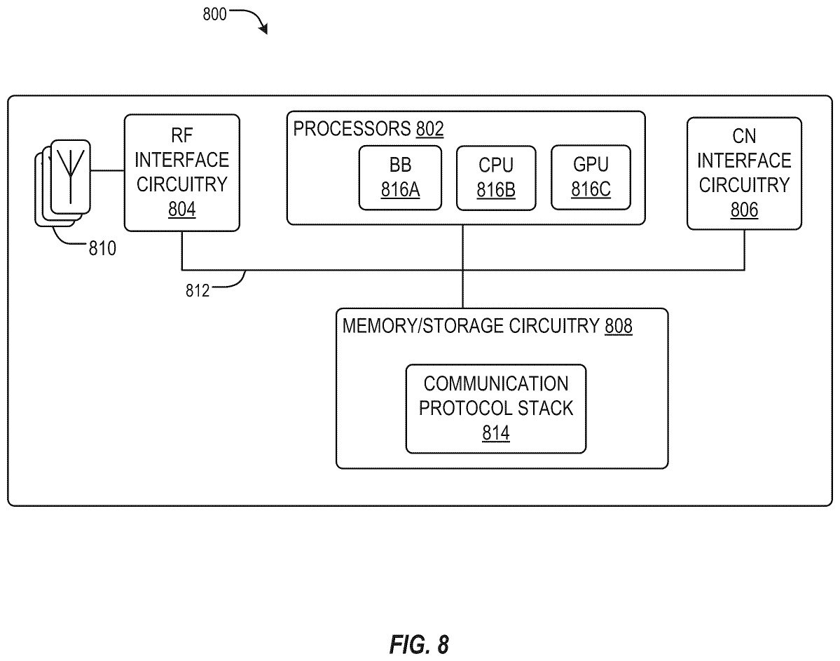

FIG. 8 illustrates an example access node 800 (e.g., a base station or gNB). The access node 800 may be similar to and substantially interchangeable with base station 104. The access node 800 may include one or more of processor 802, RF interface circuitry 804, core network (CN) interface circuitry 806, memory/storage circuitry 808, and one or more antenna(s) 810. The processor 802 may include any type of circuitry or processor circuitry that executes or otherwise operates computer-executable instructions, such as program code, software modules, or functional processes from memory/storage circuitry 808 to cause the access node 800 to perform operations as described herein.

The components of the access node 800 may be coupled with various other components over one or more interconnects 812. The processor 802, RF interface circuitry 804, memory/storage circuitry 808 (including communication protocol stack 814), antenna(s) 810, and interconnects 812 may be similar to like-named elements shown and described with respect to FIG. 7. For example, the processor 802 may include processor circuitry such as, for example, baseband processor circuitry (BB) 816A, central processor unit circuitry (CPU) 816B, and graphics processor unit circuitry (GPU) 816C.

The CN interface circuitry 806 may provide connectivity to a core network, for example, a 5th Generation Core network (5GC) using a 5GC-compatible network interface protocol such as carrier Ethernet protocols, or some other suitable protocol. Network connectivity may be provided to/from the access node 800 via a fiber optic or wireless backhaul. The CN interface circuitry 806 may include one or more dedicated processors or FPGAs to communicate using one or more of the aforementioned protocols. In some implementations, the CN interface circuitry 806 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 800 that operates in an NR or 5G system (for example, a gNB), and the term “E-UTRAN node” or the like may refer to an access node 800 that operates in an LTE or 4G system (e.g., an eNB). According to various implementations, the access node 800 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 800 may be implemented as one or more software entities running on server computers as part of a virtual network, which may be referred to as a CRAN and/or a virtual baseband unit pool (vBBUP). In V2X scenarios, the access node 800 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112 (f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc., as described above in connection with one or more of the preceding figures may be configured to operate in accordance with one or more of the examples set forth below.

Example 1 is a method including: establishing a voice communication session using a first cell of a wireless communication network; initiating a first timer based at least on determining, from one or more measurements corresponding to the voice communications session using the first cell, that at least one radio channel condition of the first cell is below a threshold; initiating a second timer after transmitting a measurement report indicating the one or more measurements corresponding to the voice communications session using the first cell; determining RLF upon expiration of the first timer or the second timer; and performing a connection reestablishment procedure in response to determining RLF.

Example 2 includes the method of example 1, where an expiration period of at least one of the first timer or the second timer is less than an RTP timeout period, and where determining RLF upon expiration of the first timer or the second timer includes determining RLF before the RTP timeout period has ended.

Example 3 includes the method of any of examples 1 to 2, where determining RLF upon expiration of the first timer or the second timer includes determining RLF in response to determining that (i) the first timer has expired and (ii) the measurement report is being transmitted.

Example 4 includes the method of any of examples 1 to 3, where determining RLF upon expiration of the first timer or the second timer includes determining RLF in response to determining that (i) the second timer has expired and (ii) a mobility handover command has not been received from the wireless communication network.

Example 5 includes the method of any of examples 1 to 4, further including: suspending or resetting the first timer based at least on determining, from one or more subsequent measurements corresponding to the voice communication session using the first cell, that the at least one radio channel condition of the first cell is above the threshold.

Example 6 includes the method of any of examples 1 to 5, further including: monitoring the first cell for a mobility handover command after transmitting the measurement report; and suspending or resetting the second timer based at least on receiving the mobility handover command in response to receiving a mobility handover command before expiration of the second timer.

Example 7 includes the method of any of examples 1 to 6, where performing the connection reestablishment procedure includes initiating an RRC reestablishment procedure with a second cell based at least on determining that at least one radio channel condition of the second cell is (i) above the threshold or (ii) better than the first cell.

Example 8 includes the method of any of examples 1 to 7, where performing the connection reestablishment procedure includes initiating a handover from the first cell to a second cell prior to receiving a mobility handover command from the wireless communication network.

Example 9 includes the method of any of examples 12 to 8, further including transferring the voice communication session from the first cell to a second cell after determining RLF.

Example 10 includes the method of any of examples 1 to 9, where the at least one radio channel condition includes at least one of SNR, SINR, RSRP, or RSRQ.

Example 11 includes the method of any of examples 1 to 10, where the voice communication session includes a VoLTE call, a VoNR call, or an EPSFB call.

Example 12 includes the method of any of examples 1 to 11, where the first timer, the second timer, and the threshold are preconfigured.

Example 13 is an apparatus including: one or more processors; and memory storing instructions that, when executed by the one or more processors, cause the apparatus to perform the method of any of examples 1-12, or any other method or process described herein.

Example 14 is a UE including at least one processor configured to perform the method of any of examples 1-12, or any other method or process described herein.

Example 15 is a baseband processor configured to perform the method of any of examples 1-12, or any other method or process described herein.

Example 16 is a non-transitory computer-readable medium storing instructions that, when executed by one or more processors, cause the one or more processors to perform the method of any of examples 1-12, or any other method or process described herein.

Example 17 includes an apparatus including logic, modules, and/or circuitry (e.g., processing circuitry) that is configured to perform the method of any of examples 1-12, or any other method or process described herein.

Example 18 is a method including: initiating a first timer during a voice communication session based on determining, from one or more measurements of a first cell, that at least one radio channel condition of the first cell is below a threshold; initiating a second timer after transmitting a measurement report indicating the one or more measurements of the first cell; and declaring RLF upon expiration of the first timer or the second timer.

Example 19 includes the method of example 18, further including establishing the voice communication session using the first cell, where the one or more measurements are performed during the voice communication session.

Example 20 includes the method of any of examples 18-19, where an expiration period of at least one of the first timer or the second timer is less than an RTP timeout period.

Example 21 includes the method of example 20, where declaring RLF upon expiration of the first timer or the second timer includes declaring RLF before the RTP timeout period has ended.

Example 22 includes the method of any of examples 18-21, where declaring RLF upon expiration of the first timer or the second timer includes determining RLF in response to determining that (i) the first timer has expired and (ii) the measurement report is being transmitted.

Example 23 includes the method of any of examples 18-22, where declaring RLF upon expiration of the first timer or the second timer includes declaring RLF in response to determining that (i) the second timer has expired and (ii) a mobility handover command has not been received.

Example 24 includes the method of any of examples 18-23, further including: suspending or resetting the first timer based on determining, from one or more subsequent measurements corresponding to the voice communication session using the first cell, that the at least one radio channel condition of the first cell is above the threshold.

Example 25 includes the method of any of examples 18-24, further including: monitoring the first cell for a mobility handover command after transmitting the measurement report; and suspending or resetting the second timer based on receiving the mobility handover command in response to receiving a mobility handover command before expiration of the second timer.

Example 26 includes the method of any of examples 18-25, further including performing a connection reestablishment procedure in response to declaring RLF.

Example 27 includes the method of example 26, where performing the connection reestablishment procedure includes initiating an RRC reestablishment procedure with a second cell based on determining that at least one radio channel condition of the second cell is (i) above the threshold or (ii) better than the first cell.

Example 28 includes the method of any of examples 26-27, where performing the connection reestablishment procedure includes initiating a handover from the first cell to a second cell prior to receiving a mobility handover command.

Example 29 includes the method of any of examples 18-28, further including transferring the voice communication session from the first cell to a second cell after declaring RLF.

Example 30 includes the method of any of examples 18-29, where the at least one radio channel condition includes at least one of SNR, SINR, RSRP, or RSRQ.

Example 31 includes the method of any of examples 18-30, where the voice communication session includes a VoLTE call, a VoNR call, or an EPSFB call.

Example 32 includes the method of any of examples 18-31, where the first timer, the second timer, and the threshold are preconfigured.

Example 33 is an apparatus including: one or more processors; and memory storing instructions that, when executed by the one or more processors, cause the apparatus to perform operations including: initiating a first timer during a voice communication session based on determining, from one or more measurements of a first cell, that at least one radio channel condition of the first cell is below a threshold; initiating a second timer after transmitting a measurement report indicating the one or more measurements of the first cell; and declaring RLF upon expiration of the first timer or the second timer.

Example 34 includes the apparatus of example 33, the operations further including establishing the voice communication session using the first cell, where the one or more measurements are performed during the voice communication session.

Example 35 includes the apparatus of any of examples 33-34, where an expiration period of at least one of the first timer or the second timer is less than an RTP timeout period.

Example 36 includes the apparatus of example 35, where declaring RLF upon expiration of the first timer or the second timer includes declaring RLF before the RTP timeout period has ended.

Example 37 is a baseband processor configured to perform operations including: initiating a first timer during a voice communication session based on determining, from one or more measurements of a first cell, that at least one radio channel condition of the first cell is below a threshold; initiating a second timer after transmitting a measurement report indicating the one or more measurements of the first cell; and declaring RLF upon expiration of the first timer or the second timer.

The previously described examples can be implemented as a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

An apparatus (e.g., a UE) including one or more baseband processors, and so forth, can be configured to perform particular operations or actions by virtue of having software, firmware, and/or hardware that, in operation, cause the apparatus to perform any of the foregoing operations.

Any of the foregoing examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

We claim:

1. A method comprising:
initiating a first timer during a voice communication session based at least on determining, from one or more measurements of a first cell, that at least one radio channel condition of the first cell is below a threshold;
initiating a second timer after transmitting a measurement report indicating the one or more measurements of the first cell; and
declaring radio link failure (RLF) upon expiration of the first timer or the second timer.

2. The method of claim 1, further comprising establishing the voice communication session using the first cell, wherein the one or more measurements are performed during the voice communication session.

3. The method of claim 1, wherein an expiration period of at least one of the first timer or the second timer is less than a real-time transport protocol (RTP) timeout period.

4. The method of claim 3, wherein declaring RLF upon expiration of the first timer or the second timer comprises declaring RLF before the RTP timeout period has ended.

5. The method of claim 1, wherein declaring RLF upon expiration of the first timer or the second timer comprises determining RLF in response to determining that (i) the first timer has expired and (ii) the measurement report is being transmitted.

6. The method of claim 1, wherein declaring RLF upon expiration of the first timer or the second timer comprises declaring RLF in response to determining that (i) the second timer has expired and (ii) a mobility handover command has not been received.

7. The method of claim 1, further comprising:
suspending or resetting the first timer based at least on determining, from one or more subsequent measurements corresponding to the voice communication session using the first cell, that the at least one radio channel condition of the first cell is above the threshold.

8. The method of claim 1, further comprising:
monitoring the first cell for a mobility handover command after transmitting the measurement report; and
suspending or resetting the second timer based at least on receiving the mobility handover command in response to receiving a mobility handover command before expiration of the second timer.

9. The method of claim 1, further comprising performing a connection reestablishment procedure in response to declaring RLF.

10. The method of claim 9, wherein performing the connection reestablishment procedure comprises initiating a radio resource control (RRC) reestablishment procedure with a second cell based at least on determining that at least one radio channel condition of the second cell is (i) above the threshold or (ii) better than the first cell.

11. The method of claim 9, wherein performing the connection reestablishment procedure comprises initiating a handover from the first cell to a second cell prior to receiving a mobility handover command.

12. The method of claim 1, further comprising transferring the voice communication session from the first cell to a second cell after declaring RLF.

13. The method of claim 1, wherein the at least one radio channel condition comprises at least one of a signal to noise ratio (SNR), a signal to interference and noise ratio (SINR), a reference signal received power (RSRP), or a reference signal received quality (RSRQ).

14. The method of claim 1, wherein the voice communication session comprises a voice over Long-Term Evolution (VoLTE) call, a voice over New Radio (VoNR) call, or an evolved packet switched fallback (EPSFB) call.

15. The method of claim 1, wherein the first timer, the second timer, and the threshold are preconfigured.

16. An apparatus comprising:
one or more processors; and
memory storing instructions that, when executed by the one or more processors, cause the apparatus to perform operations comprising:
initiating a first timer during a voice communication session based on determining, from one or more measurements of a first cell, that at least one radio channel condition of the first cell is below a threshold;
initiating a second timer after transmitting a measurement report indicating the one or more measurements of the first cell; and
declaring RLF upon expiration of the first timer or the second timer.

17. The apparatus of claim 16, the operations further comprising establishing the voice communication session using the first cell, wherein the one or more measurements are performed during the voice communication session.

18. The apparatus of claim 16, wherein an expiration period of at least one of the first timer or the second timer is less than an RTP timeout period.

19. The apparatus of claim 18, wherein declaring RLF upon expiration of the first timer or the second timer comprises declaring RLF before the RTP timeout period has ended.

20. A baseband processor configured to perform operations comprising:
initiating a first timer during a voice communication session based on determining, from one or more measurements of a first cell, that at least one radio channel condition of the first cell is below a threshold;
initiating a second timer after transmitting a measurement report indicating the one or more measurements of the first cell; and
declaring RLF upon expiration of the first timer or the second timer.
